(19) United States
(12) Patent Application Publication
(10) Pub. No.: US 2024/0333671 A1
(43) Pub. Date: Oct. 3, 2024

(54) GLOBAL BLOCKLIST CURATION BASED ON CROWDSOURCED INDICATORS OF COMPROMISE

(71) Applicant: KnowBe4, Inc., Clearwater, FL (US)

(72) Inventors: Anand Dinkar Bodke, Pune (IN); Mark William Patton, Clearwater, FL (US); Eric Howes, Dunedin, FL (US); Steffan Perry, New Port Richey, FL (US)

(73) Assignee: KnowBe4, Inc., Clearwater, FL (US)

(21) Appl. No.: 18/621,695

(22) Filed: Mar. 29, 2024

Related U.S. Application Data
(60) Provisional application No. 63/456,266, filed on Mar. 31, 2023.

(51) Int. Cl. H04L 51/212; H04L 51/42

(52) U.S. Cl. CPC H04L 51/212; H04L 51/42

(57) ABSTRACT

Systems and methods are described herein for global blocklist curation based on crowdsourced indicators of compromise (IoC). One or more servers store the messages reported as suspicious into a message collection system. The server(s) classify he messages as one of clean, spam or threat. The server(s)) tag the messages responsive to the classification and determine a plurality of IoC from the messages classified and tagged as a threat. The server(s) determine one or more metrics for each of the plurality of IoC and selected, based at least on the one or more metrics, one or more of the plurality of IoC as blocklist entry (BLE) candidates.

### RELATED APPLICATIONS

This patent application claims the benefit of and priority to U.S. Provisional Patent Application No. 63/456,266 titled “GLOBAL BLOCKLIST CURATION BASED ON CROWDSOURCED INDICATORS OF COMPROMISE” and filed Mar. 31, 2023, the contents of all of which are hereby incorporated herein by reference in its entirety for all purposes.

### FIELD OF DISCLOSURE

This disclosure relates to security management. In particular, the present disclosure relates to systems and methods for global blocklist curation based on crowdsourced indicators of compromise (IoC).

### BACKGROUND OF THE DISCLOSURE

Cybersecurity incidents cost companies millions of dollars each year in actual costs and can cause customers to lose trust in an organization. The incidents of cybersecurity attacks and the costs of mitigating the damage is increasing every year. Many organizations use cybersecurity tools such as antivirus, anti-ransomware, anti-phishing, and other quarantine platforms to detect and intercept known cybersecurity attacks. However, new and unknown security threats involving social engineering may not be readily detectable by such cyber security tools, and the organizations may have to rely on their employees (referred to as users) to recognize such threats. To enable their users to stop or reduce the rate of cybersecurity incidents, the organizations may conduct security awareness training for their users. The organizations may conduct security awareness training through in-house cybersecurity teams or may use third parties which are experts in matters of cybersecurity. The security awareness training may include cybersecurity awareness training, for example, via simulated phishing attacks, computer-based training, and such training programs. Through security awareness training, organizations educate their users on how to detect and report suspected phishing communication, avoid clicking on malicious links, and use applications and websites safely.

### BRIEF SUMMARY OF THE DISCLOSURE

Systems and methods are provided for global blocklist curation based on crowdsourced indicators of compromise (IoC). In an example embodiment, a method is described for receiving, by one or more servers, messages that have been reported by users of one or more organizations. In examples, the one or more servers store the messages into a message collection system. In some embodiments, the method includes classifying, by the one or more servers, the messages as one of clean, spam or threat. In examples, the one or more servers tag the messages responsive to the classification. In some embodiments, the method includes determining, by the one or more servers, a plurality of IoC from the messages classified and tagged as threat. In some embodiments, the method includes determining, by the one or more servers, one or more metrics for each of the plurality of IoC. In some embodiments, the method includes selecting, by the one or more servers based at least on the one or more metrics, one or more of the plurality of IoC as blocklist entry (BLE) candidates.

In some embodiments, the method further includes providing the BLE candidates to a system administrator of an organization for selection to be included in a private blocklist.

In some embodiments, the method further includes removing from the messages classified as a threat, messages with a timestamp of receipt in a reporting user's mailbox before a predetermined time period before the classification.

In some embodiments, the method further includes excluding from the plurality of IoC any IoC on a BLE exclusion list.

In some embodiments, the method further includes determining one or more metrics comprising a severity metric representing an extent of harm to an organization a message having an IoC can cause.

In some embodiments, the method further includes determining one or more metrics comprising a breadth metric comprising a proportion of a number of organizations in which an IoC is included in the plurality of IoC from classified messages for a time period.

In some embodiments, the method further includes determining one or more metrics comprising a prevalence metric comprising a count of a number of times an IoC is included in the plurality of IoC from classified messages for a time period.

In some embodiments, the method further includes excluding as BLE candidates the plurality of IoC with one or more metrics below a threshold value for the respective metric, wherein the one or more metrics comprises a prevalence metric or a breadth metric.

In some embodiments, the method further includes determining, by an artificial intelligence model, which of the BLE candidates are approved to be included in the blocklist, the artificial intelligence model being trained on previous BLE candidates.

In some embodiments, the method further includes outputting as BLE candidates each of the selected plurality of IoC with the one or more metrics.

In another example embodiment, a system is described for global blocklist curation based on crowdsourced IoC. In some embodiments, the system includes one or more servers. The one or more servers are configured to receive messages that have been reported by users of one or more organizations. In examples, the one or more servers store the messages into a message collection system. In some embodiments, the one or more servers are configured to classify the messages as one of clean, spam or threat and tag the messages responsive to the classification. In some embodiments, the one or more servers are configured to determine a plurality of IoC from the messages classified and tagged as threat. In some embodiments, the one or more servers are configured to determine one or more metrics for each of the plurality of IoC. In some embodiments, the one or more servers are configured to select based at least on the one or more metrics, one or more of the plurality of IoC as BLE candidates.

In some embodiments, the one or more servers are further configured to provide the BLE candidates to a system administrator of an organization for selection to be included in a private blocklist.

In some embodiments, the one or more servers are further configured to remove from the messages classified as a threat, messages with a timestamp of receipt in a reporting user's mailbox before a predetermined time period before the classification.

In some embodiments, the one or more servers are further configured to exclude from the plurality of IoC any IoC on a BLE exclusion list.

In some embodiments, the one or more servers are further configured to determine one or more metrics comprising a severity metric representing an extent of harm to an organization a message having an IoC can cause.

In some embodiments, the one or more servers are further configured to determine one or more metrics comprising a breadth metric comprising a proportion of a number of organizations in which an IoC is included in the plurality of IoC from classified messages for a time period.

In some embodiments, the one or more servers are further configured to determine one or more metrics comprising a prevalence metric comprising a count of a number of times an IoC is included in the plurality of IoC from classified messages for a time period.

In some embodiments, the one or more servers are further configured to exclude as BLE candidates the plurality of IoC with one or more metrics below a threshold value for the respective metric, wherein the one or more metrics comprises a prevalence metric or a breadth metric.

In some embodiments, the one or more servers are further configured to determine via an artificial intelligence model, which of the BLE candidates are approved to be included in the blocklist, the artificial intelligence model being trained on previous BLE candidates.

In some embodiments, the one or more servers are further configured to output as BLE candidates each of the selected plurality of IoC with the one or more metrics.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIG. 1C and FIG. 1D are block diagrams depicting embodiments of computing devices useful in connection with the methods and systems described herein;

FIG. 2A depicts an implementation of some of a server architecture of a system capable of global blocklist curation based on crowdsourced indicators of compromise (IoC), according to some embodiments;

FIG. 2B depicts an implementation of a message classifier, according to some embodiments;

FIG. 2C depicts an implementation of a BLE candidate selector, according to some embodiments;

FIG. 2D depicts an implementation of a BLE candidate review unit, according to some embodiments;

FIG. 3 depicts an example of message processing using a message classifier, according to some embodiments;

FIG. 4 depicts an example of a message processing flow from the message classifier to blocklists, according to some embodiments;

FIG. 5 depicts a flowchart for selecting one or more of plurality of IoC as BLE candidates, according to some embodiments; and

FIG. 6A, FIG. 6B and FIG. 6C depict a flowchart for providing BLE candidates to a system administrator of an organization to be included in a private blocklist, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods that are useful for global blocklist curation based on crowdsourced indicators of compromise (IoC).

### A. Computing and Network Environment

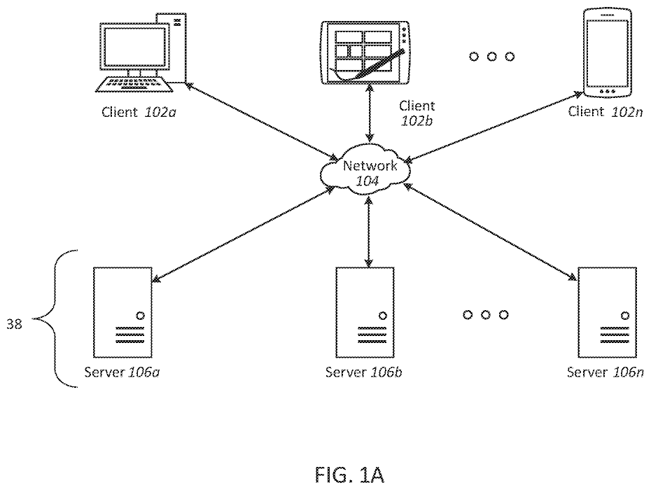

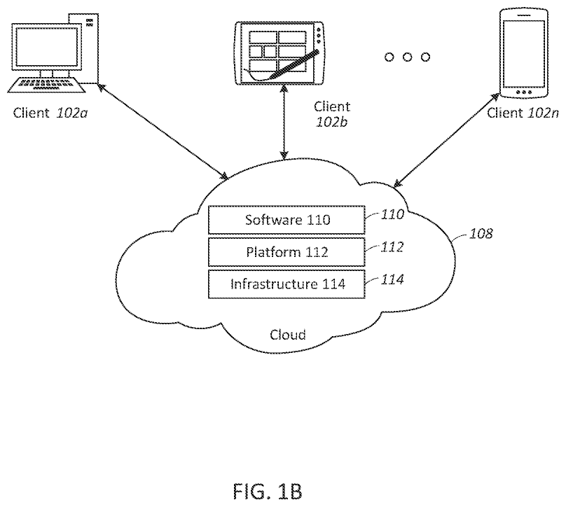

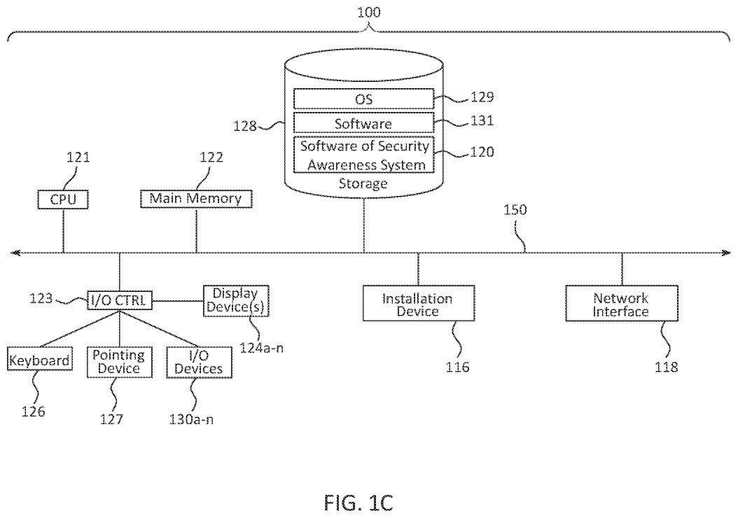

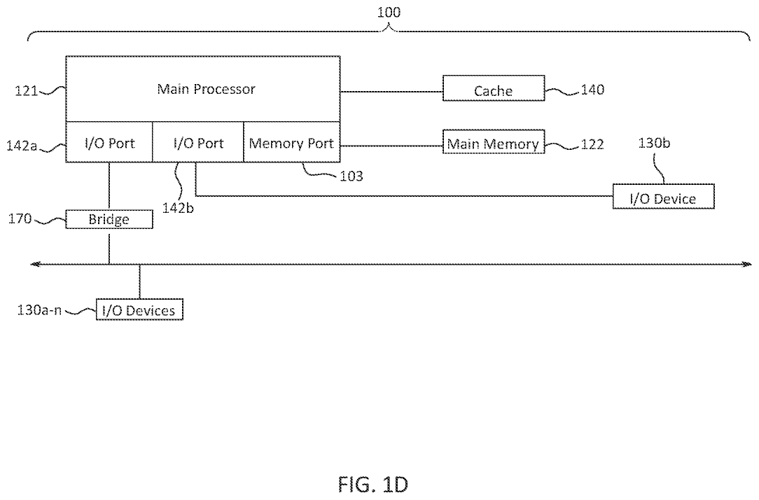

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g., Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP Internet protocol suite may include application layer, transport layer, Internet layer (including, e.g., Ipv4 and Ipv6), or the link layer. The network 104 may be a type of broadcast network, a telecommunications network, a data communication network, or a computer network.

In some embodiments, the system may include multiple, logically grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous-one or more of the servers 106 or machines 106 can operate according to one type of operating system platform (e.g., Windows, manufactured by Microsoft Corp. of Redmond, Washington), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include Vmware ESX/ESXi, manufactured by VMWare, Inc., of Palo Alta, California; the Xen hypervisor, an open source product whose development is overseen by Citrix Systems, Inc. of Fort Lauderdale, Florida; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, California.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud-based delivery, e.g., Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Washington, Rackspace Cloud provided by Rackspace Inc. of San Antonio, Texas, Google Compute Engine provided by Google Inc. of Mountain View, California, or RightScale provided by RightScale, Inc. of Santa Barbara, California. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Washington, Google App Engine provided by Google Inc., and Heroku provided by Heroku, Inc. of San Francisco California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, California, or Office365 provided by Microsoft Corporation. Examples of SaaS may also include storage providers, e.g., Dropbox provided by Dropbox Inc. of San Francisco, California, Microsoft OneDrive provided by Microsoft Corporation, Google Drive provided by Google Inc., or Apple iCloud provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. Google Chrome, Microsoft Internet Explorer, or Mozilla Firefox provided by Mozilla Foundation of Mountain View, California). Clients 102 may also access SaaS resources through smartphone or tablet applications, including e.g., Salesforce Sales Cloud, or Google Drive App. Clients 102 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client 102 or a server 106. As shown in FIG. 1C and FIG. 1D, each computing device 100 includes a central processing unit (CPU) 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an Operating System (OS) 129, software 131, and software of a security awareness system 120. As shown in FIG. 1D, each computing device 100 may also include additional optional elements, e.g., a memory port 103, a bridge 170, one or more Input/Output (I/O) devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the central processing unit 121. Main memory unit 122 may be volatile and faster than storage 128 memory. Main memory units 122 may be Dynamic Random-Access Memory (DRAM) or any variants, including Static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile Random Access Memory (NVRAM), flash memory, non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the central processing unit 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the central processing unit 121 communicates directly with cache memory 140 via a secondary bus, sometimes referred to as a backside bus. In other embodiments, the central processing unit 121 communicates with cache memory 140 using the system bus 150. Cache memory 140 typically has a faster response time than main memory 122 and is typically provided by SRAM, BSRAM, or EDRAM. In the embodiment shown in FIG. 1D, the central processing unit 121 communicates with various I/O devices 130 via a local system bus 150. Various buses may be used to connect the central processing unit 121 to any of the I/O devices 130, including a PCI bus, a PCI-X bus, a PCI-Express bus, or a NuBus. For embodiments in which the I/O device is a video display 124, the central processing unit 121 may use an Advanced Graphic Port (AGP) to communicate with the display 124 or the I/O controller 123 for the display 124. FIG. 1D depicts an embodiment of a computer 100 in which the central processing unit 121 communicates directly with I/O device 130b or other central processing units 121′ via HYPERTRANSPORT, RAPIDIO, or INFINIBAND communications technology. FIG. 1D also depicts an embodiment in which local busses and direct communication are mixed: the central processing unit 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen displays, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices 130a-130n may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation device 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode (LED) displays, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One of ordinary skill in the art will recognize and appreciate the various ways and embodiments that a computing device 100 may be configured to have multiple display devices 124a-124n.

Referring again to FIG. 1C, the computing device 100 may comprise storage device 128 (e.g., one or more hard disk drives or redundant arrays of independent disks) for storing an operating system or other related software, and for storing application software programs such as any program related to the software of security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices 128 may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116 and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.1 la/b/g/n/ac CDMA, GSM, WiMAX, and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Washington; MAC OS and iOS, manufactured by Apple, Inc.; and Linux, a freely-available operating system, e.g., Linux Mint distribution (“distro”) or Ubuntu, distributed by Canonical Ltd. Of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the iPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple lossless audio file formats and .mov, .m4v, and .mp4 MPEG-4 (H.264/MPEG-4 AVC) video file formats.

In some embodiments, the computing device 100 is a tablet e.g., the iPAD line of devices by Apple; GALAXY TAB family of devices by Samsung; or KINDLE FIRE, by Amazon.com, Inc. of Seattle, Washington. In other embodiments, the computing device 100 is an eBook reader, e.g. the KINDLE family of devices by Amazon.com, or NOOK family of devices by Barnes & Noble, Inc. of New York City, New York.

In some embodiments, the communications device 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Global Blocklist Curation Based on Crowdsourced Indicators of Compromise

The following describes systems and methods for global blocklist curation based on crowdsourced indicators of compromise (IoC).

Organizations may implement anti-phishing mechanisms (for example, anti-phishing software products) to identify and stop phishing attacks (or cybersecurity attacks) before phishing messages reach the users. These anti-phishing mechanisms may rely on a database of threat definition files (also called signatures, blocklist entries (BLE), or indicators of compromise (IoC)) to stop malicious attacks associated with phishing messages. However, phishing messages having new signatures or involving new techniques may evade the anti-phishing mechanisms and may reach users. A new phishing attack that has not yet been identified is called a Zero-Day attack. The length of time for a signature (or a threat definition file) to be released for a new phishing attack may be several days whereas the first victim of a phishing attack typically falls for it within minutes of its release. Therefore, existing signature-based systems are of little use for Zero-Day attacks. In examples, a first indication of a Zero-Day attack to an organization is when the Zero-Day attack reaches a mailbox of a user of the organization. Consequently, the organizations may be at a security risk, possibly leading to breach of the organization's sensitive information if the users were to act upon the phishing messages that may form part of the Zero-Day attack.

In examples, third-party antivirus software products and operating system security options such as Microsoft Defender rely on threat definition files to identify and block incoming phishing messages. Since, it takes time for Zero-Day attacks to be reflected in threat definition files and for updated threat definition files to be transmitted to corporate systems, the organizations may be vulnerable for that time period. In an example, each phishing message may include several characteristics, each of which could be used to block further instances of the phishing message or its variants before the phishing message or its variants reach additional users. These characteristics may be used to create one or more BLEs in a blocklist. In an example, a BLE may be understood as a single rule that relates to a characteristic of an email threat (phishing message) that may be used by an email server to quarantine email threats. In examples, each BLE may be of a single characteristic type which, when present in an inbound email, provides an indication to the email server that the email is malicious. The BLE characteristic types may include sender characteristic type (such as sender email address or sender domain), body URLs characteristic type (such as URL domain or URL path, wildcards supported for both), and attachment characteristic type (such as SHA256 hash of the attachment). There may be a limit as to how many BLEs of each different characteristic type may be supported. Therefore, it is essential that the BLEs that make up the blocklist are capable of preventing Zero-Day attacks from reaching users of the organizations. Accordingly, systems and methods to provide faster protection from Zero-Day attacks based on one or more blocklists are needed.

Blocklists may protect organizations by blocking emails that match a set of blocklist rules included in the blocklists. In examples, Microsoft 365 (Office365) supports a limited number of types of blocklist rules, including sender email addresses, sender domains, domains found in the email body, uniform resource locator (URLs) found in the email body (which may be wildcarded), and attachments (by SHA256 hash of the attachments). In an example, SHA256 hash may be a cryptographic hash function.

The present disclosure describes systems and methods for global blocklist curation based on crowdsourced indicators of compromise (IoC). The systems and methods enable faster protection from Zero-Day attacks by providing BLEs created based on recently reported threats to organizations.

A message may include one or more IoC. The IoC may be any piece of data that is included within a message that has been classified as a threat. Examples of IoC include:
Filename of an attachment to the message;
IP address of a forwarding email server (Mail Transport Agent, MTA), a URL of an embedded hyperlink, originator email header fields (From, Sender, Reply-To), etc.
IP addresses (e.g., of servers or devices that are known to host malicious content or participate in harmful activities, such as spamming, phishing, malware distribution, etc.);
Domain names (e.g., associated with malicious websites, such as phishing sites, malware distribution sites, or sites hosting malicious ads);
URLs (e.g., that are associated with malicious content, such as downloads of malware or phishing pages;
File hashes (e.g., cryptographic hash values of known malicious files, such as malware or exploits);
Email addresses (e.g., that are known to send spam or phishing messages);
User agents (e.g., the string identifying the software used by a client which may be used for malicious activities, such as scraping websites for information or launching DDOS attacks);
Autonomous System Numbers (ASNs) (which are unique numerical labels assigned to organizations and used in routing on the Internet) associated with known malicious actors;
Country codes (such as “CN” for China) that are associated with a high volume of malicious activity, such as spam or phishing;
MAC addresses that may be used in malicious activities, such as exploiting network vulnerabilities or launching DDOS attacks; and
Registry keys that have been modified by malware to maintain persistence on an infected system.

A BLE may include includes following BLE characteristics:
Identifier (e.g., the unique identifier for the entity, such as an IP address, domain name, file hash, or URL);
Threat type (e.g., the type of threat or malicious activity associated with the entity, such as malware, phishing, spam, or network intrusion);
Source (e.g., the source of the information used to create the blocklist entry, such as a security researcher, anti-virus software, or network intrusion detection system);
Date and time (e.g., the date and time when the entry was added to the blocklist); and
TTL (e.g., the time to live, or the duration for which the entry may remain in the blocklist before being removed or expired (for example, automatically)).

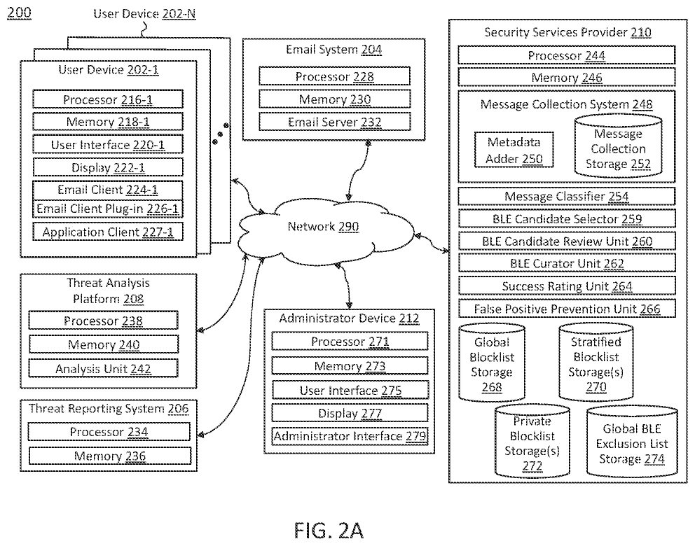

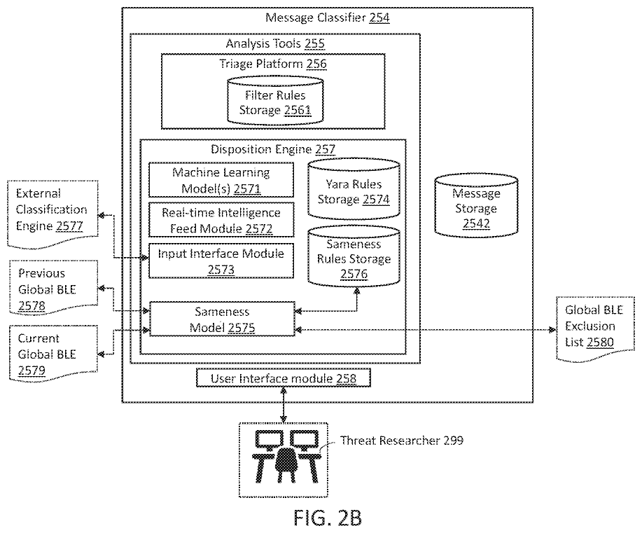

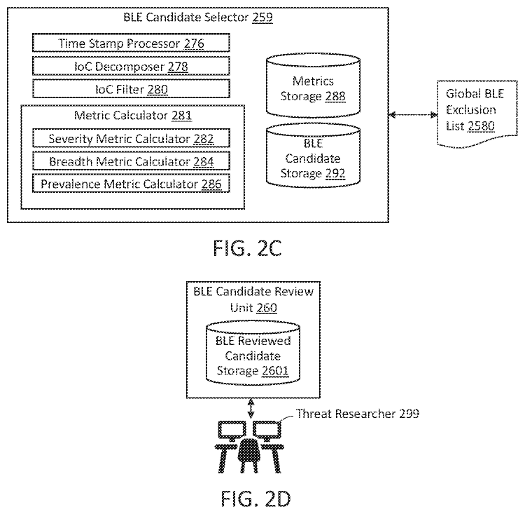

Referring to FIG. 2A, in a general overview, FIG. 2A depicts some of the server architecture of an implementation of system 200 capable of global blocklist curation based on crowdsourced indicators of compromise (IoC), according to some embodiments. System 200 may be a part of security awareness system 120. System 200 may include user device(s) 202-(1-N), email system 204, threat reporting system 206, threat analysis platform 208, security services provider 210, administrator device 212, and network 290 enabling communication between the system components for information exchange. Network 290 may be an example or instance of network 104, details of which are provided with reference to FIG. 1A and its accompanying description.

According to some embodiments, each of email system 204, threat reporting system 206, threat analysis platform 208, security services provider 210, and administrator device 212 may be implemented in a variety of computing systems, such as a mainframe computer, a server, a network server, a laptop computer, a desktop computer, a notebook, a workstation, and the like. In an implementation, email system 204, threat reporting system 206, threat analysis platform 208, security services provider 210, and administrator device 212 may be implemented in a server, such as server 106 shown in FIG. 1A. In some implementations, email system 204, threat reporting system 206, threat analysis platform 208, and security services provider 210 may be implemented by a device, such as computing device 100 shown in FIG. 1C and FIG. 1D. In some embodiments, email system 204, threat reporting system 206, threat analysis platform 208, security services provider 210, and administrator device 212 may be implemented as a part of a cluster of servers. In some embodiments, each of email system 204, threat reporting system 206, threat analysis platform 208, security services provider 210, and administrator device 212 may be implemented across a plurality of servers, thereby, tasks performed by each of email system 204, threat reporting system 206, threat analysis platform 208, security services provider 210, and administrator device 212 may be performed by the plurality of servers. These tasks may be allocated among the cluster of servers by an application, a service, a daemon, a routine, or other executable logic for task allocation.

Referring again to FIG. 2A, in one or more embodiments, user device 202-(1-N) may be any device used by a user (all devices of user device 202-(1-N) are subsequently referred to as user device 202-1 however, the description may be generalized to any of user device 202-(1-N)). The user may be an employee of an organization, a client, a vendor, a customer, a contractor, a system administrator (interchangeably referred to as an administrator), or any person associated with the organization. User device 202-1 may be any computing device, such as a desktop computer, a laptop, a tablet computer, a mobile device, a Personal Digital Assistant (PDA), or any other computing device. In an implementation, user device 202-1 may be a device, such as client device 102 shown in FIG. 1A and FIG. 1B. User device 202-1 may be implemented by a device, such as computing device 100 shown in FIG. 1C and FIG. 1D. According to some embodiments, user device 202-1 may include processor 216-1 and memory 218-1. In an example, processor 216-1 and memory 218-1 of user device 202-1 may be CPU 121 and main memory 122, respectively, as shown in FIG. 1C and FIG. 1D. User device 202-1 may also include user interface 220-1, such as a keyboard, a mouse, a touch screen, a haptic sensor, a voice-based input unit, or any other appropriate user interface. It shall be appreciated that such components of user device 202-1 may correspond to similar components of computing device 100 in FIG. 1C and FIG. 1D, such as keyboard 126, pointing device 127, I/O devices 130a-n and display devices 124a-n. User device 202-1 may also include display 222-1, such as a screen, a monitor connected to the device in any manner, or any other appropriate display, which may correspond to similar components of computing device 100, for example display devices 124a-n. In an implementation, user device 202-1 may display received content (for example, messages) for the user using display 222-1 and is able to accept user interaction via user interface 220-1 responsive to the displayed content.

In some embodiments, user device 202-1 may include email client 224-1 and application client 227-1. In one example, email client 224-1 may be a cloud-based application that may be accessed over network 290 without being installed on user device 202-1. In an implementation, email client 224-1 may be any application capable of composing, sending, receiving, and reading email messages. In an example, email client 224-1 may facilitate a user to create, receive, organize, and otherwise manage email messages. In an implementation, email client 224-1 may be an application that runs on user device 202-1. In some implementations, email client 224-1 may be an application that runs on a remote server or on a cloud implementation and is accessed by a web browser. For example, email client 224-1 may be an instance of an application that allows viewing of a desired message type, such as any web browser, Microsoft Outlook™ application (Microsoft, Mountain View, California), IBM® Lotus Notes® application, Apple® Mail application, Gmail® application (Google, Mountain View, California), WhatsApp™ (Facebook, Menlo Park, California), a text messaging application, or any other known or custom email application. In an example, a user of user device 202-1 may be mandated to download and install email client 224-1 on user device 202-1 by the organization. In an example, email client 224-1 may be provided by the organization as default. In some examples, a user of user device 202-1 may select, purchase and/or download email client 224-1 through an application distribution platform. In some examples, user device 202-1 may receive simulated phishing communications or actual malicious phishing communications via email client 224-1. User device 202-1 may also include application client 227-1. In an implementation, application client 227-1 may be a client side program or a client side application that is run on user device 202-1. In examples, application client 227-1 may be a desktop application, mobile application, etc. Other user devices 202-(2-N) may be similar to user device 202-1.

In one or more embodiments, email client 224-1 may include email client plug-in 226-1. An email client plug-in may be an application or program that may be added to an email client for providing one or more additional features or customizations to existing features. The email client plug-in may be provided by the same entity that provides the email client software or may be provided by a different entity. In an example, email client plug-in may provide a User Interface (UI) element such as a button to enable a user to trigger a function. Functionality of client-side plug-ins that use a UI button may be triggered when a user clicks the button. Some examples of client-side plug-ins that use a button UI include, but are not limited to, a Phish Alert Button (PAB) plug-in, a task create plug-in, a spam marking plug-in, an instant message plug-in, a social media reporting plug-in and a search and highlight plug-in. In an embodiment, email client plug-in 226-1 may be any of the aforementioned types or may be of any other type.

In some implementations, email client plug-in 226-1 may not be implemented in email client 224-1 but may coordinate and communicate with email client 224-1. In some implementations, email client plug-in 226-1 is an interface local to email client 224-1 that supports email client users. In one or more embodiments, email client plug-in 226-1 may be an application that supports the user, i.e., recipients of messages, to select to report suspicious messages that they believe may be a threat to them or their organization. Other implementations of email client plug-in 226-1 not discussed here are contemplated herein. In one example, email client plug-in 226-1 may provide the PAB plug-in through which functions or capabilities of email client plug-in 226-1 are triggered/activated by a user action on the button. Upon activation, email client plug-in 226-1 may forward content (for example, suspicious messages) to a system administrator. In some embodiments, email client plug-in 226-1 may cause email client 224-1 to forward content to the system administrator, or an Incident Response (IR) team of the organization for threat triage or threat identification. The system administrator may be an individual or team responsible for managing organizational cybersecurity aspects on behalf of an organization. For example, the system administrator may oversee Information Technology (IT) systems of the organization for configuration of system personal information use, identification and classification of threats within reported emails. Examples of system administrator include an IT department, a security administrator, a security team, a manager, or an Incident Response (IR) team. In some embodiments, email client 224-1 or email client plug-in 226-1 may send a notification to threat reporting system 206 that a user has reported content received at email client 224-1 as potentially malicious. Thus, in examples, the PAB plug-in button enables a user to report suspicious content. User device 202-1 may also include application client 227-1. In an implementation, application client 227-1 may be a client side program or a client side application that is run on user device 202-1. In examples, application client 227-1 may be a desktop application, mobile application, etc.

Referring again to FIG. 2A, email system 204 may be an email handling system owned or managed or otherwise associated with an organization or any entity authorized thereof. In an implementation, email system 204 may be configured to receive, send, and/or relay outgoing emails between message senders (for example, third-party to the organization) and recipients (for example, user devices 202-(1-N)). In an implementation, email system 204 may include processor 228, memory 230, and email server 232. In an example, processor 228 and memory 230 of email system 204 may be CPU 121 and main memory 122, respectively, as shown in FIG. 1C and FIG. 1D.

In an implementation, email server 232 may be any server capable of handling, receiving, and delivering emails over network 290 using one or more standard email protocols and standards, such as Post Office Protocol 3 (POP3), Internet Message Access Protocol (IMAP), Simple Mail Transfer Protocol (SMTP), and Multipurpose Internet Mail Extension (MIME). Email server 232 may be a standalone server or a part of an organization's server. In an implementation, email server 232 may be implemented using, for example, Microsoft® Exchange Server, and HCL Domino®. In an implementation, email server 232 may be server 106 shown in FIG. 1A.

In some embodiments, threat reporting system 206 may be a platform that enables users to report messages that the users find to be suspicious or believe to be malicious, through email client plug-ins 226-(1-N) or any other suitable means. In some examples, threat reporting system 206 may be configured to manage a deployment of and interactions with email client plug-ins 226-(1-N), allowing the users to report the suspicious messages directly from email clients 224-(1-N). According to some embodiments, threat reporting system 206 may include processor 234 and memory 236. For example, processor 234 and memory 236 of threat reporting system 206 may be CPU 121 and main memory 122, respectively, as shown in FIG. 1C and FIG. 1D.

According to some embodiments, threat analysis platform 208 may be a platform that monitors, identifies, and manages cybersecurity attacks including phishing attacks faced by the organization or by users within the organization. In an implementation, threat analysis platform 208 may be configured to analyze messages that are reported by users to detect any cybersecurity attacks such as phishing attacks via malicious messages. A malicious message may be a message that is designed to trick a user into causing the download of malicious software (for example, viruses, Trojan horses, spyware, or worms) that is of malicious intent onto a computer. The malicious message may include malicious elements. A malicious element is an aspect of the malicious message that, when interacted with, downloads or installs malware onto a computer. Examples of the malicious element include a URL or link, an attachment, and a macro. The interactions may include clicking on a link, hovering over a link, copying a link and pasting it into a browser, opening an attachment, downloading an attachment, saving an attachment, attaching an attachment to a new message, creating a copy of an attachment, executing an attachment (where the attachment is an executable file), and running a macro. The malware (also known as malicious software) is any software that is used to disrupt computer operations, gather sensitive information, or gain access to private computer systems. Examples of malicious messages include phishing messages, smishing messages, vishing messages, malicious IM, or any other electronic message designed to disrupt computer operations, gather sensitive information, or gain access to private computer systems. Threat analysis platform 208 may use information collected from identified cybersecurity attacks and analyze messages to prevent further cybersecurity attacks.

According to some embodiments, threat analysis platform 208 may include processor 238 and memory 240. For example, processor 238 and memory 240 of threat analysis platform 208 may be CPU 121 and main memory 122, respectively, as shown in FIG. 1C and FIG. 1D. According to an embodiment, threat analysis platform 208 may include analysis unit 242. In an implementation, analysis unit 242 may be an application or a program communicatively coupled to processor 238 and memory 240. In some embodiments, analysis unit 242, amongst other units, may include routines, programs, objects, components, data structures, etc., which may perform particular tasks or implement particular abstract data types. Analysis unit 242 may also be implemented as signal processor(s), state machine(s), logic circuitries, and/or any other device or component that manipulate signals based on operational instructions.

In some embodiments, analysis unit 242 may be implemented in hardware, instructions executed by the processing module, or by a combination thereof. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to performing the required functions. In some embodiments, analysis unit 242 may be machine-readable instructions which when executed by a processor/processing module, perform intended functionalities of analysis unit 242. The machine-readable instructions may be stored on an electronic memory device, hard disk, optical disk, or other machine-readable storage medium or non-transitory medium. In an implementation, the machine-readable instructions may also be downloaded to the storage medium via a network connection. In an example, machine-readable instructions may be stored in memory 240.

Referring back to FIG. 2A, in some embodiments, security services provider 210 may be an entity that performs global blocklist curation based on crowdsourced IoC. The global blocklist may be a collection of global BLEs that make up the blocklist and may be published by security services provider 210. The global blocklist may be available to organizations that subscribe to the services of security services provider 210. According to some embodiments, security services provider 210 may include processor 244 and memory 246. For example, the processor 244 and memory 246 of security services provider 210 may be CPU 121 and main memory 122, respectively, as shown in FIG. 1C and FIG. 1D. According to some embodiments, security services provider 210 may include message collection system 248, message classifier 254, BLE candidate selector 259, BLE candidate review unit 260, BLE curator unit 262, success rating unit 264, false positive prevention unit 266, global blocklist storage 268, stratified blocklist storage(s) 270, private blocklist storage(s) 272, and global BLE exclusion list storage 274, amongst other units, and may include routines, programs, objects, components, data structures, etc., which may perform particular tasks or implement particular abstract data types.

In some embodiments, message collection system 248, message classifier 254, BLE candidate selector 259, BLE candidate review unit 260, BLE curator unit 262, success rating unit 264, false positive prevention unit 266, global blocklist storage 268, stratified blocklist storage(s) 270, private blocklist storage(s) 272, and global BLE exclusion list storage 274 may be implemented in hardware, instructions executed by a processing module, or by a combination thereof. In examples, the processing module may be main processor 121, as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to performing the required functions. In some embodiments, message collection system 248, message classifier 254, BLE candidate selector 259, BLE candidate review unit 260, BLE curator unit 262, success rating unit 264, false positive prevention unit 266, global blocklist storage 268, stratified blocklist storage(s) 270, private blocklist storage(s) 272, and global BLE exclusion list storage 274 may be machine-readable instructions which, when executed by a processor/processing module, perform intended functionalities of message collection system 248, message classifier 254, BLE candidate selector 259, BLE candidate review unit 260, BLE curator unit 262, success rating unit 264, false positive prevention unit 266, global blocklist storage 268, stratified blocklist storage(s) 270, private blocklist storage(s) 272, and global BLE exclusion list storage 274. The machine-readable instructions may be stored on an electronic memory device, hard disk, optical disk, or other machine-readable storage medium or non-transitory medium. In an implementation, the machine-readable instructions may also be downloaded to the storage medium via a network connection.

According to an implementation, message collection system 248 may be configured to receive messages that have been reported by users of one or more organizations. Message collection system 248 may process and prepare the reported messages for disposition. Message collection system 248 may include metadata adder 250 and message collection storage 252. Metadata adder 250 may be configured to add metadata to the incoming reported messages. Examples of metadata include organization metadata, reporter metadata, and organizational analysis metadata. The organization metadata may include, but are not limited to, industry, size (for example, number of employees, market cap), and location of the organization of the reporting user. The reporter metadata may include, but are not limited to, work address (for example, number, street, city, state/province, country/region, post/zip code), manager, direct reports, group memberships, job title, and years at the organization of the reporting user. The addition of the organization metadata enables security services provider 210 to identify attributes of an organization from which the message has been received, and the addition of reporter metadata enables security services provider 210 to identify attributes of the reporter of the message. The attributes derivable by the added metadata may be used by security services provider 210 to stratify blocklists as being applicable to one or more attributes. The organizational analysis metadata may include, but are not limited to, Yet Another Ridiculous Acronym (YARA) rule labels and system administrator classification. In examples, metadata adder 250 may be configured to add a timestamp to the incoming reported messages. Message collection storage 252 may be configured to store the incoming reported messages and/or the reported messages with metadata added by metadata adder 250. In some examples, message collection system 248 communicates the metadata appended messages to message classifier 254 in a message queue.

Message classifier 254 may be configured to process the received messages and disposition the received messages as “clean”, “spam”, or “threat”. In examples, message classifier 254 may use one or more analysis tools for the disposition. Message classifier 254 and some exemplary tools used for disposition are shown in FIG. 2B. As shown in FIG. 2B, message classifier 254 includes analysis tools 255, user interface module 258, and message storage 2542. Analysis tools 255 may be configured to analyze the messages for classification. Analysis tools 255 may include tools such as triage platform 256 and disposition engine 257. Triage platform 256 may have a number of filter rules which when applied to incoming messages provides an indication as to whether a message may be “clean”, “spam” or “threat”. In examples, the filter rules are generated using triage filter(s). Examples of triage filter(s) may include:
Subject (or substring of the subject);
Sender (may be an individual sender or a collection of senders);
Attachment name (or a substring of the attachment name including use of wildcard);
Body text;
Boolean results as to whether an attachment has been read (TRUE/FALSE);
Receipt date range (e.g., received within the last 48 hours); and
X-headers.

The triage filter(s) may be used individually or in combination with filter rules. The filter rules may be stored in filter rules storage 2561. An example of the filter rules is PhishER Filter Rules (by KnowBe4, Inc, 33 N Garden Ave, Ste 1200. Clearwater, Florida, USA 33755).

Disposition engine 257 may be an analysis tool that may be configured to assign a probability that a message should be classified as “clean”, “spam” or “threat”. Disposition engine 257 may include machine learning model(s) 2571, real-time intelligence feed module 2572, input interface module 2573, YARA rules storage 2574, sameness model 2575, and sameness rules storage 2576. Machine learning model(s) 2571 may be configured to analyze the messages and generate the classification and accuracy probability. To analyze the messages and generate the classification and accuracy probability, machine learning model(s) 2571 may be trained on previously dispositioned messages where the dispositioning has been validated by, for example, threat researcher 299. Using threat researcher 299 to validate messages facilitates better training of machine learning model(s) 2571 and improves accuracy of probability. Real-time intelligence feed module 2572 may be configured to provide real-time intelligence feeds to machine learning model(s) 2571. Also, any additional contextual features that may be obtained associated with the messages may be used to refine machine learning model(s) 2571.

Input interface module 2573 may be configured to communicatively connect disposition engine 257 with external classification engine 2577. External classification engine 2577 may be an example of one or more classification engines that are outside of security services provider 210 that provide message classification services. External classification engine 2577 may be configured to receive messages from disposition engine 257. In an implementation, external classification engine 2577 may analyze and classify messages, and share results including classified messages with disposition engine 257. An example of external classification engine 2577 may include VirusTotal. VirusTotal is a product of Alphabet, Inc., which analyzes suspicious files, URLs, domains, and IP addresses to detect malware and other types of threats. In an example, disposition engine 257 may send messages to VirusTotal and may receive classification results that are shared by VirusTotal through input interface module 2573.

YARA rules storage 2574 may be configured to store YARA rules. YARA rules are a set of rules used to classify and identify malware samples by creating descriptions of malware families based on textual or binary patterns. YARA rules may be used to create descriptions of malware families. Each description (for example, known as a rule) includes a set of strings and a Boolean expression which determine its logic. Disposition engine 257 may use YARA rules for classifying messages.

Sameness model 2575 may be a probability model configured to obtain and/or apply sameness rules. Sameness rules may be used in classifying messages into threat and clean categories using known-threats and known-clean messages as a baseline. In examples, sameness model 2575 may be an Artificial Intelligence (AI) model. Sameness model 2575 may take messages (as input) that are part of current global BLE 2579 or previous global BLE 2578 as examples of threat messages. Sameness model 2575 may take messages (as input) that are part of global BLE exclusion list 2580 as examples of clean messages. Sameness model 2575 may also take messages (as input) that are dispositioned as clean by system administrators of organizations that provide reported messages to message collection system 248. Based on learning from one or more of messages from current global BLE 2579, previous global BLE 2578, global BLE exclusion list 2580, and dispositioned “clean” messages (by system administrators), sameness model 2575 generates sameness rules. Sameness model 2575 may store the sameness rules in sameness rules storage 2576.

User interface module 258 may be configured to provide access to threat researcher 299 to classify messages. In an example, threat researcher 299 may be a part of cybersecurity team who are experts in matters of cybersecurity. In some examples, user interface module 258 may provide a user interface to threat researcher 299 to analyze and classify messages. In examples, threat researcher 299 may be a machine learning (ML) model for classifying the messages that are previously unknown and may not have sufficient information that can be analyzed and classified by YARA rules, filter rules, external classification engines and/or sameness rules. Messages classified by threat researcher 299 may be received by disposition engine 257 through user interface module 258. Message classifier 254 may store the messages obtained from message collection system 248 as well as the messages that are tagged by disposition engine 257 in message storage 2542. Disposition engine 257 may use classification output information from the messages obtained from one or more of machine learning model(s) 2571, real-time intelligence feed module 2572, input interface module 2573, YARA rules storage 2574, sameness model 2575, and sameness rules storage 2576, to assign a probability that a message should be classified as “clean”, “spam” or “threat”.

Referring back to FIG. 2A, BLE candidate selector 259 may be configured to process the messages that are assigned probabilities to obtain IoC, to create message metrics, and to determine BLE candidates. FIG. 2C shows BLE candidate selector 259 in greater detail. As shown, BLE candidate selector 259 may include time stamp processor 276, IoC decomposer 278, IoC filter 280, metric calculator 281, severity metric calculator 282, breadth metric calculator 284, prevalence metric calculator 286, metrics storage 288, and BLE candidate storage 292. Time stamp processor 276 may be configured to identify and remove messages (from queue of classified messages) that are classified as threat and having timestamp of receipt in a reporting user's mailbox before a predetermined time period before the classification. In examples, the predetermined time period may be described in terms of hours. For example, the predetermined time period may be 2 hours, 4 hours, 8 hours, 16 hours, 24 hours, 36 hours, or may be 48 hours. In examples, time stamp processor 276 may remove such messages as the messages may have become too outdated to be considered as an active threat. In examples, time stamp processor 276 may determine an age of a given message by comparing a timestamp added by email client 224-1-N to the message and time at which time stamp processor 276 receives the message. In examples, time stamp processor 276 may add an additional timestamp to the one or more messages when the messages that are classified as threat and having timestamp of receipt in a reporting user's mailbox after a predetermined time period before the classification. IoC decomposer 278 may be configured to decompose the messages classified as threat and not removed by time stamp processor 276 to extract IoC.

BLE candidate selector 259 may associate metadata associated with messages classified as threat with IoC that are extracted from the messages. IoC filter 280 may be configured to filter IoC to remove the IoC from messages that are known to be exclusions. The messages that are exclusions may include permanent exclusions which are included in a global BLE exclusion list (for example, global BLE exclusion list 2580 as is illustrated in FIG. 2C) and IoC from new messages classified as clean or spam.

BLE candidate selector 259 may be configured to use metric calculator 281 to determine one or more metrics for one or more IoC. Examples of metric include severity metric, breadth metric, and prevalence metric. The severity metric for an IoC may be a representation of an extent of harm to an organization a message which includes the IoC may cause. For example, an IoC which is representative of a ransomware attack may be assigned a higher severity metric than an IoC which is representative of a malware attack. Similarly, denial of service attack may be assigned lower severity metric than ransomware but a higher severity metric than a malware attack, and so on. Other examples of assigning severity metrics for different attacks are contemplated herein. In an example, one or more IoC may be assigned a severity metric.

The breadth metric for an IoC may, for example be a count representing the number of organizations in which the IoC appears in the IoC extracted from messages of a queue of classified messages from a given period of time (for example, from the last 8 hours or the last 12 hours). The breadth metric in examples may be expressed as the percentage of organizations from which the IoC appears in the IoC extracted from messages of a queue of classified messages from a given period of time (for example, from the last 12 hours). In an example, one or more IoC may be assigned a breadth metric.

The prevalence metric for an IoC may, for example be a count representing the number of times the IoC appears in the IoC extracted from messages of a queue of classified messages from a given period of time (for example, from the last 8 hours or the last 12 hours). The prevalence metric in examples may be expressed as the percentage of times the IoC appears in the IoC extracted from messages of a queue of classified messages from a given period of time (for example, from the last 12 hours). In an example, one or more IoC may be assigned a prevalence metric. In examples, the prevalence metric may include an aspect of the breadth metric representing a rate of change of the percentage of organizations from which the IoC appears in the IoC extracted from messages of a queue of classified messages from a given period of time. For example, a Zero-Day scenario may be very prevalent. As security services providers 210 update BLE based on detection, attackers may realize that their attack is not working after a period in time. Consequently, attackers may stop sending the same or similar attacks and the prevalence metric of attacks that include the IoC detected by that BLE may go down. In examples, the rate at which the prevalence metric or the rate at which the breadth metric changes may be an indicator that an IoC may be becoming ‘stale’, meaning that attacks that utilize that IoC may be becoming less prevalent and the BLE that detects the IoC may not still be relevant.

In an example, BLE candidate selector 259 may use severity metric calculator 282 to calculate a severity metric of one or more IoC. BLE candidate selector 259 may use breadth metric calculator 284 and prevalence metric calculator 286 to calculate a breadth metric of one or more IoC and a prevalence metric of one or more IoC, respectively. BLE candidate selector 259 may store the IoC, metrics associated with IoC, and messages associated with the IoC in metrics storage 288. BLE candidate selector 259 may select at least one or more of the plurality of IoC as BLE candidates based at least on the one or more metrics. In examples, BLE candidate selector 259 may store the BLE candidates along with metrics in BLE candidate storage 292.

Referring back to FIG. 2A, BLE candidate review unit 260 may be configured to provide one or more BLE candidates to threat researcher 299 for additional analysis. BLE candidate review unit 260 may receive approval or rejection of the BLE candidates from threat researcher 299 as shown in FIG. 2D. In some examples, BLE candidate review unit 260 may be an AI model configured to review the one or more BLE candidates. The AI model may be trained on previous BLE candidates that have been “Approved for Release” (for example, approved BLE candidates) and previous BLE candidates that have been rejected. BLE candidate review unit 260 may include BLE reviewed candidate storage 2601 to store approved or rejected BLE candidates.

Referring back to FIG. 2A, BLE curator unit 262 may be configured to curate approved BLE candidates into a global blocklist which is released to one or more organizations. In examples, BLE curator unit 262 may use metadata that are associated with approved BLE candidates to create one or more stratified blocklists. For example, BLE curator unit 262 may use approved BLE candidates which have industry metadata to create stratified blocklists for one or more industries that also have the industry metadata and may release the stratified blocklist to organizations in the one or more industries. For example, BLE candidates that are relevant for the insurance industry may not be relevant for the mining industry, and so stratified blocklists comprising BLE with industry metadata related to insurance industries would not be provided to companies associated with the mining industry. The stratified blocklists may cater specifically to relevant industries. In some examples, BLE curator unit 262 may use approved BLE candidates which have associated location metadata to create stratified blocklists for one or more locations that are released to organizations in the one or more locations. In examples, BLE curator unit 262 may order BLE candidates in global blocklist and/or stratified blocklists according to one or more metadata or according to one or more metrics. In examples, BLE curator unit 262 may generate a BLE candidate score by associating numerical values with one or more of prevalence metric, breadth metric, severity metric, and age associated with a BLE candidate and combining the numerical values. In examples, BLE curator unit 262 may provide options to the organizations to generate private blocklists by facilitating selection by the organizations by ordering or ranking the BLE candidates in a global blocklist or stratified blocklist. The BLE curator unit 262 may range BLE candidates in a global blocklist differently for different organizations. In examples, BLE curator unit 262 may provide stratified blocklists relevant to an industry of the organization and allow the organization to create or update their private blocklist with BLE candidates from the stratified blocklist. Based on the selection by the organization, BLE curator unit 262 may provide, alter, update or reorder BLE candidate recommendations provided to an organization to be added to the private blocklist of the organization.

Success rating unit 264 may determine success ratings for BLE candidates from global blocklists and/or stratified blocklists which have been included and deployed in private blocklists of organizations. The success of a BLE candidate may be determined based on how many messages the BLE candidate identifies based on the IoC in the messages matching or aligning with the BLE candidate, where the identified messages are verified to be threat. False positive prevention unit 266 may be configured to identify BLE candidates that are creating false positives (for examples, messages that are not actually threat). A BLE candidate may be determined to have generated a false positive if a message is identified by the BLE candidate based on the IoC in the message matching or aligning with the BLE candidate, and the identified message is verified to be clean or spam (i.e., the messages is verified not to be threat. In examples, if the number of false positives that are generated by a BLE candidate over a period of time exceed a threshold, BLE curator unit 262 may remove such BLE candidates from a global blocklist or a stratified blocklist(s). In examples, if the number of successes identified for a BLE candidate over a period of time is lower than a threshold, BLE curator unit 262 may remove such BLE candidates from a global blocklist or a stratified blocklist. In examples, instead of or in addition to removing a BLE candidate from a global blocklist or a stratified blocklist, BLE curator unit 262 may recommend to a system administrator of an organization to remove the BLE candidate from a private blocklist of the organization. In examples, BLE curator unit 262 may provide the number of success and/or number of false positives over a period of time to the system administrator together with the recommendation.

In some embodiments, security services provider 210 may include global blocklist storage 268, stratified blocklist storage(s) 270, private blocklist storage(s) 272, and global BLE exclusion list storage 274. In an implementation, global blocklist storage 268 may include one or more global blocklists, for example a current global blocklist and one or more previous global blocklists. In an implementation, stratified blocklist storage(s) 270 may include stratified blocklist(s). In an implementation, private blocklist storage(s) 272 may include one or more private blocklists from one or more organizations. In an implementation, global BLE exclusion list storage 274 may include one or more global BLE exclusion lists. In examples, global blocklists stored in global blocklist storage 268, stratified blocklist(s) stored in stratified blocklists storage(s) 270, private blocklist(s) stored in private blocklist storage(s) 272, and global BLE exclusion lists stored in global BLE exclusion list storage 274 may be periodically or dynamically updated as required.

In some embodiments, administrator device 212 may be any device used by a user or a system administrator or a security administrator to perform administrative duties. The system administrator may be an individual or team responsible for managing organizational cybersecurity aspects on behalf of an organization. The system administrator may oversee and manage blocklists of an organization including private blocklists. In an example, the system administrator may oversee Information Technology (IT) systems of the organization for configuration of system personal information use, and for the identification and classification of threats within reported emails. Examples of system administrator include an IT department, a security administrator, a security team, a manager, or an Incident Response (IR) team. In an implementation, administrator device 212 may be any computing device, such as a desktop computer, a laptop, a tablet computer, a mobile device, a Personal Digital Assistant (PDA), smart glasses, or any other computing device. In an implementation, administrator device 212 may be a device, such as client device 102 shown in FIG. 1A and FIG. 1B. Administrator device 212 may be implemented by a device, such as computing device 100 shown in FIG. 1C and FIG. 1D. According to some embodiments, administrator device 212 may include processor 271 and memory 273. In an example, processor 271 and memory 273 of administrator device 212 may be CPU 121 and main memory 122, respectively, as shown in FIG. 1C and FIG. 1D. Administrator device 212 may also include user interface 275, such as a keyboard, a mouse, a touch screen, a haptic sensor, a voice-based input unit, or any other appropriate user interface. It shall be appreciated that user interface 275 of administrator device 212 may correspond to similar components of computing device 100 in FIG. 1C and FIG. 1D, such as keyboard 126, pointing device 127, I/O devices 130a-n and display devices 124a-n. In some embodiments, administrator device 212 may include display 277, such as a screen, a monitor connected to the device in any manner, a wearable glass, or any other appropriate display. In some implementations, administrator device 212 may include administrator interface 279. Administrator interface 279 may be supported by a library, an application programming interface (API), a set of scripts, or any other code that may enable the system administrator to interact with security services provider 210, threat analysis platform 208, threat reporting system 206, and email system 204, for example to manage blocklists and other components of system 200.

In operation, a user of user device 202-1 may receive a message (for example, an email) in his or her mailbox. In an implementation, the user may receive the message from email system 204. On receiving the message, if the user suspects that the message is suspicious and potentially malicious, the user may report the message using email client plug-in 226-1. In an implementation where email client plug-in 226-1 provides a UI element such as a button in email client 224-1 of user device 202-1 and when the user suspects that the message is malicious, the user may click on the UI element to report the message. The user may click on the UI element using, for example, a mouse pointer, and the user may click on the UI element when the message is open or when the message is highlighted in a list of inbox messages.

In some implementations, when the user selects to report the message via email client plug-in 226-1, email client plug-in 226-1 may receive an indication that the message was reported by the user of user device 202-1 as a suspected malicious message. In response, email client plug-in 226-1 may cause email client 224-1 to forward the reported message or a copy of the reported message to threat reporting system 206 or security services provider 210. Threat reporting system 206 may forward the reported message or a copy of the reported message to threat analysis platform 208 for threat analysis. In some examples, the user may proactively forward the message to a system administrator who, in turn, may send the message to threat reporting system 206 and/or threat analysis platform 208. According to an implementation, upon receiving the reported message or the copy of the reported message, threat analysis platform 208 may process the reported message to determine whether the message is a malicious message. Various combinations of reporting, retrieving, and forwarding the message to threat reporting system 206 and threat analysis platform 208 not described are contemplated herein.

In a similar manner as described above, threat reporting system 206 may receive messages that have been reported, for example, by one or more users of the organization. Threat analysis platform 208 may analyze the reported messages. In examples, threat analysis platform 208 may identify or classify a plurality of messages from amongst the reported messages as threat. According to an implementation, analysis unit 242 of threat analysis platform 208 may add metadata to each of the plurality of messages. The metadata may assist in the identification of potential threats in the plurality of messages. In examples, adding metadata to the messages may enable the system administrator to prioritize assessment of the messages that are most likely to be threats. According to some embodiments, analysis unit 242 may analyze the reported messages to identify the plurality of messages as threats. In some examples, a system administrator of an organization may opt in to sharing the emails reported by user(s) of the organization with security services provider 210. In examples, shared reported messages may be associated with one or more of the metadata described above.

In some examples, message collection system 248 may receive the shared reported messages (which were reported by user(s)) through threat analysis platform 208. In some examples, message collection system 248 may receive the reported messages directly from one or more user devices 202-1-N. Message collection system 248 may store the received messages in message collection storage 252. In some examples, the messages received by message collection system 248 may not include metadata. The reported messages may not have metadata, for example in situations where the reported messages may not have been analyzed by the organizations and/or in situations where the reported message was directly received from the users. In some examples, the messages received by message collection system 248 may include metadata. For example, reported messages may have metadata added to them by threat analysis platform 208. Threat analysis platform 208 may include one or more tools used in the organization that adds metadata, for example, YARA rules created by a system administrator for use as part of threat analysis platform 208 or metadata may be by security endpoint systems. In some examples, a system administrator or threat analysis platform 208 may analyze reported messages and classify the messages as “spam”, “clean” or “threat”. Threat analysis platform 208 may add the classification to the reported message as metadata. In some examples, a timestamp may be added by threat analysis platform 208 or by threat reporting system 206 to indicate a time of reporting.

Metadata adder 250 may add additional metadata to the reported messages, for example, related to the organization and/or the user(s) who reported the message. In some examples, metadata adder 250 may add a timestamp (for example, “year: month: day: hour: min: sec”) to a reported message. Message collection system 248 may store the messages with appended metadata in message collection storage 252. Message collection system 248 may communicate the messages with appended metadata to message classifier 254 in a queue.

Message classifier 254 may receive messages coming in the queue from message collection system 248 and store the messages in message storage 2542. In an example, message classifier 254 may use various analysis tools such as triage platform 256 and disposition engine 257 to process these messages. Triage platform 256 may use one or more triage filters to create one or more filter rules. For example, triage platform 256 may use sender and attachment name to create a filter rule. Triage platform 256 may apply the one or more filter rules to incoming messages. In an example, triage platform 256 may apply the filter rules on the messages through an interface which provides one or more query fields that can be used in searching the messages matching the rule. In some examples, the filter rules of triage platform 256 may be written as Structured Query Language (SQL) queries and used in querying message storage 2542. Other examples of application of the filter rules not explained here are contemplated. The application of the triage rules may result in an indication as to whether the message is “clean”, “spam” or “threat. Triage platform 256 may attach the indication to the message. The indication when used with indications from other tools in analysis tools 255 may facilitate in disposition of the message.

Disposition engine 257 may process the messages with the indications for disposition. In examples, disposition engine 257 may use machine learning model(s) 2571 on the messages to analyze and determine the classification and accuracy probability of the classification. In examples, disposition engine 257 may use the subject and body text, and punctuation (which are individually tokenized) of a message in its machine learning model(s) 2571 to analyze and classify the messages. In some examples, disposition engine 257 may use real-time intelligence feeds in the classification of messages. In an example, disposition engine 257 may use uses real-time intelligence feed module 2572 to receive and provide real-time intelligence feeds to machine learning model(s) 2571. The real-time intelligence feeds may include features of contextual feature(s) of the message. In examples, disposition engine 257 may use the additional contextual features of the reported messages to refine machine learning model(s) 2571. Machine learning model(s) 2571 may generate a classification and accuracy probability of the classification based on the analysis. Disposition engine 257 may associate the classification and accuracy probability of the classification with the analyzed message.

Disposition engine 257 may use inputs provided by the other tools to enhance and improve the probability of classification of messages. Some inputs to disposition engine 257 include, but are not limited to, inputs from external classification engine results (such as VirusTotal Intelligence (VTI) results provided by VirusTotal), results of YARA rules, and inputs from the sameness rules. In some examples, disposition engine 257 may send the messages to VirusTotal for analysis and may receive classification results (for example, VTI results) that are shared by VirusTotal through input interface module 2573. Disposition engine 257 may associate the inputs from VirusTotal with the message. Disposition engine 257 may also use the inputs for analysis. In some examples, disposition engine 257 may use YARA rules stored in YARA rules storage 2574 to classify the messages. In examples, YARA rules may use wild-cards, case-insensitive strings, regular expressions, and special operators. An example of YARA rule is shown below (Source: https://yara.readthedocs.io/en/v3.7.0/).

```
rule silent_banker : banker
{
  meta:
    description = “This is just an example”
    thread_level = 3
    in_the_wild = true
  strings:
    $a = {6A 40 68 00 30 00 00 6A 14 8D 91}
    $b = {8D 4D B0 2B C1 83 C0 27 99 6A 4E 59 F7 F9}
    $c = “UVODFRYSIHLNWPEJXQZAKCBGMT”
  condition:
    $a or $b or $c
    }
```

As shown in the example, the structure of the YARA rule includes an identifier, “silent banker”, and a tag, “banker” which gets appended to messages that match the YARA rule. The above YARA rule indicates that any file containing one of the three strings ($a, $b, or $c) is reported as silent_banker and is tagged with “banker”. Disposition engine 257 may tag the message with classification probability if the YARA rules are met. In some examples, disposition engine 257 may use input from the application of sameness rules on the messages, for determining a probability that a message should be classified as “clean”, “spam”, or “threat”.

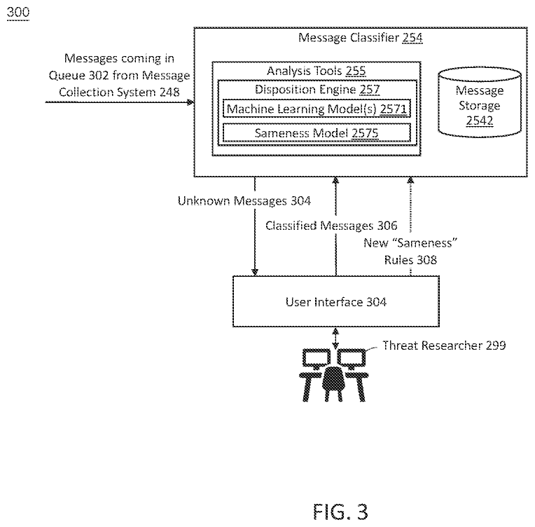

In examples, there may be some messages that are previously unknown and message classifier 254 may not have sufficient information that can be analyzed by machine learning model(s) 2571, sameness model 2575, YARA rules, filter rules, VTI results or real-time intelligence feeds, and the probability of classifying the messages may not be high. In such instances, disposition engine 257 may be configured to present such messages to threat researcher 299 for classification. This is shown in FIG. 3. In particular, FIG. 3 depicts example 300 of message processing using message classifier 254, according to some embodiments.

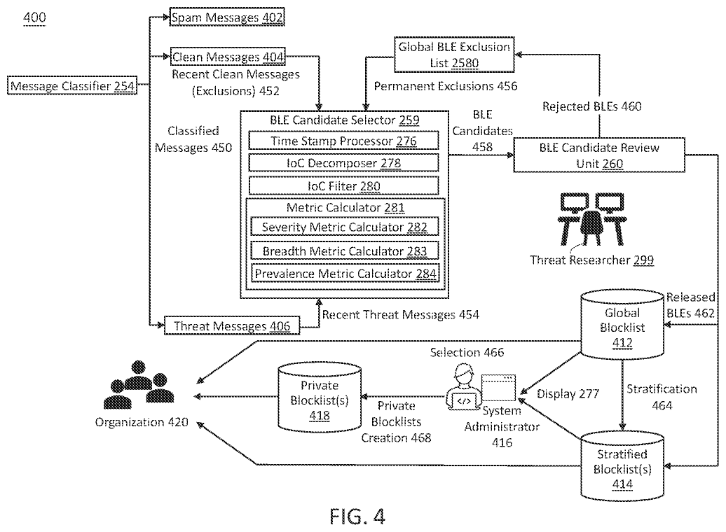

In the example shown in FIG. 3, messages coming in queue (302) from message collection system 248 may be processed by message classifier 254. In examples, unknown messages (which are illustrated as unknown messages 304 in FIG. 3) where the probability of classifying the messages may not be high may be presented by message classifier 254 to threat researcher 299. Threat researcher 299 may consider metadata associated with the unknown messages and any tags or metadata added by any of the other analysis tools of message classifier 254 in making the decision about the message classification. Threat researcher 299 may analyze, classify, and tag the messages with their classifications (which are illustrated as classified messages 306 in FIG. 3). In examples, disposition engine 257 may provide the classified message into sameness model 2575 as a known-threat or known-clean message, thereby enhancing message classification knowledge of sameness model 2575 (which is illustrated as new “sameness” rules 308). Message classifier 254 may store the messages obtained from message collection system 248 as well as the messages that are tagged by disposition engine 257 in message storage 2542. Message classifier 254 may use the classification and accuracy probability by machine learning model(s) 2571, and probability results from YARA rules, filter rules, VTI results and/or sameness model 2575 to classify messages as “spam”, “clean” or “threat”. In examples, output queue of classified messages from message classifier 254 is provided to BLE candidate selector 259. Output from message classifier 254 is shown in FIG. 4. In particular, FIG. 4 depicts example 400 of a message processing flow from message classifier 254 to blocklists. In the example shown in FIG. 4, message classifier 254 may provide classified messages (for example, classified messages 450 including spam messages 402, clean messages 404 and threat messages 406 as illustrated in FIG. 4) to BLE candidate selector 259. In examples, clean messages 404 may include recent clean messages which are exclusions 452 and threat messages 406 may include recent threat messages 454 (as illustrated in FIG. 4). In examples, messages classified as spam messages 402 may not be provided to BLE candidate selector 259.

BLE candidate selector 259 may receive and process classified messages 450 (including recent clean messages which are exclusions 452, recent threat messages 454, and permanent exclusions 456) for further disposition of messages (or verification of the dispositioning of messages), to obtain IoC, to create IoC metrics, and to determine BLE candidates. According to an implementation, messages classified as threat are first processed by time stamp processor 276. Time stamp processor 276 may analyze a timestamp of the messages and may remove any classified messages with a timestamp of receipt in a reporting user's mailbox before a predetermined time period before the classification from the queue of classified messages 450. In some examples, the predetermined time period may be 48 hours. In some examples, the predetermined time period may be 36 hours. Other exemplary time periods are contemplated herein. Time stamp processor 276 may remove classified messages 450 with a timestamp before a predetermined time period as the messages may be outdated and may not represent recent threats that users have caught and that could be potential Zero-Day attack messages. Messages that remain after processing by time stamp processor 276 and that are classified as threat may be decomposed by IoC decomposer 278 to extract IoC. BLE candidate selector 259 may associate metadata associated with messages classified as a threat with IoC that are extracted from the messages. BLE candidate selector 259 may use IoC filter 280 to compare the IoC of the messages with exclusions. BLE candidate selector 259 may remove any IoC that are identified in the exclusions by IoC filter 280 from the BLE candidates. The exclusions may be included in global BLE exclusion lists. In examples, the exclusions may be decomposed the messages that have IoC that have been shown to not constitute a feature of a threat message.

For the remaining IoC, BLE candidate selector 259 may use metric calculator 281 to determine one or more metrics for each IoC including severity metric, breadth metric, and prevalence metric. In an example, BLE candidate selector 259 may use severity metric calculator 282, breadth metric calculator 284, and prevalence metric calculator 286 to calculate severity metric, breadth metric, and prevalence metric, respectively. In an example, BLE candidate selector 259 may output one instance of each IoC tagged with corresponding prevalence metric, breadth metric, and severity metric as BLE candidates (which are illustrated as BLE candidates 458 in FIG. 4). In examples, BLE candidate selector 259 may associate metadata associated with an IoC with a BLE candidate. In an example, BLE candidate selector 259 may include a subset of the IoC in the BLE candidates, where IoC with the lowest prevalence metrics and/or the lowest breadth metrics are excluded from the BLE candidates. In examples, messages with IoC having lowest prevalence metrics and/or the lowest breadth metrics may be classified as clean. In such instances, the IoC associated with messages classified as clean may be used in analyzing incoming messages to remove any message having IoC similar to IoC of message classified as clean. In examples, such IoC may be added to global BLE exclusion list 2580 to prevent analysis of messages containing the IoC in the future.

In examples, one or more BLE candidates may be presented to threat researcher 299 for an additional manual review through an interface provided by BLE candidate review unit 260. BLE candidate review unit 260 may receive approval or rejection of BLE candidates. In some examples, BLE candidate review unit 260 may add BLE candidates rejected by threat researcher 299 to global BLE exclusion list 2580 (which are illustrated as rejected BLEs 460 in FIG. 4). In some examples, BLE candidates that are accepted or approved by threat researcher 299 may be indicated as “Approved for Release” by BLE candidate review unit 260 and may added to the released BLEs (which are illustrated as released BLEs 462 in FIG. 4). In some examples, BLE candidate review unit 260 may be an AI model configured to review the one or more BLE candidates to approve or reject the BLE candidates.

The approved BLE candidates (also referred to as “released BLEs 462” may be curated to generate a global blocklist (which is illustrated as global blocklist 412 in FIG. 4) and one or more stratified blocklists (for example, through stratification 464 to generate stratified blocklists(s) 414 as is illustrated in FIG. 4). In examples, the approved BLE candidates (released BLEs 462) that are included in global blocklist or stratified blocklist(s) may be ordered by one or more metadata. For example, the approved BLE candidates that are included in global blocklist or stratified blocklist(s) may be ordered by prevalence metric, by breadth metric, by severity metric, or by age of the first instance of a message which included the IoC that the approved BLE candidate was derived from. In an example, the approved BLE candidates that are included in global blocklist or stratified blocklist(s) may be ordered by industry prevalence or prevalence in an organization itself (for example, organization 420 as is illustrated in FIG. 4).

In examples, a numerical value may be associated with one or more of the prevalence metric, breadth metric, severity metric, and age associated with a BLE candidate. In an implementation, a combined score may be derived from the numerical values associated with the one or more of the prevalence metric, breadth metric, severity metric, and age associated with a BLE candidate. In examples, the BLE candidates in global blocklist or stratified blocklist(s) may be ordered according to the combined score. The combined score may, in examples, be a weighted average of the numerical values of the prevalence metric, breadth metric, severity metric, and age. In an example, global blocklist or stratified blocklist(s) that is released to organization 420 may be presented to a system administrator (for example, system administrator 416 as is illustrated in FIG. 4) via a user interface on a display (for example, display 277 as is illustrated in FIG. 4) and system administrator 416 may choose which BLE candidates in global blocklist and/or stratified blocklist(s) to include in the private blocklist (for example, private blocklists creation 468 through selection 466 as is illustrated in FIG. 4). In an example, global blocklist or stratified blocklist(s) may be used to automatically update or supplement the private blocklist(s) (for example, private blocklist(s) 418 as is illustrated in FIG. 4) of organization 420.

For example, the global blocklist or stratified blocklist may be provided to organization 420 as a “menu” of BLE candidates (for example, through administrator interface 279) that is custom-selectable based on needs and preferences of organization 420. The system administrator 416 of organization 420 may select/filter BLE candidates for inclusion in private blocklist of organization 420 using user interface 275 (e.g., in addition to other BLEs in the private blocklist of organization 420 that may have been previously selected by organization 420), for example by using a series of controls to prioritize BLE candidates.

In examples, an organization may configure blocklist entries from both private and global blocklists. In an example, a subset of BLE candidates of global blocklist or stratified blocklist(s) may be selected for the organization by an AI agent (for example, BLE candidate review unit 260) for inclusion in the organization's private blocklist(s). The prioritization for manual selection or the selection by the AI agent of BLE candidates for inclusion in an organization's private blocklist may be based on:
Success Rating;
Global prevalence;
Prevalence on the organization's network;
Prevalence in the organization's industries;
Other relevant metadata; and
False positive tolerance rating of the organization.

In some examples, security services provider 210 may provide a time-to-live (TTL) associated with each global BLE. The TTL may be associated with/related to prevalence metric, breadth metric, severity metric, or age associated with the BLE candidate in global blocklist or stratified blocklist(s). In examples, TTL may refer to a duration for which the BLE will remain in the blocklist before being automatically removed or expired. In examples, the TTL for a BLE candidate may vary depending on the specific blocklist and the type of BLE candidate. Some blocklists may have a fixed TTL for all BLE, while others may have a dynamic TTL that depends on the severity of the threat that the BLE is expected to be applicable to, or the likelihood of the threat that the BLE is expected to be applicable to being re-used. In examples, a dynamic TTL may be based on the success rating of the BLE, such that when the success rating drops sufficiently, the TTL decreases until the BLE expires when the success rating drops below a minimum threshold. In some examples, a BLE candidate may have a TTL of a few hours or days, while in other cases a BLE candidate may have a TTL of several months or even years. The purpose of the TTL is to ensure that the blocklist remains recent and relevant, as threat landscape is constantly evolving, and new threats emerge on a regular basis. If a BLE candidate's duration in a blocklist exceed the TTL for the BLE, security services provider 210 may remove the BLE candidate from the current global blocklist or stratified blocklist(s). In examples, the security services provider 210 may provide options to the system administrator (for example using display 277 or administrator interface 279) to remove or replace the BLE candidate. In examples, security services provider 210 may provide a more recent BLE candidate in place of removed BLE candidates, for inclusion in a global or stratified blocklist. In examples, BLE curator unit 262 may provide BLE candidate recommendations to the system administrator (for example using display 277 or administrator interface 279) to choose newer and potentially more relevant BLE candidates. The system administrator may accept the recommendations which may remove or overwrite the BLE candidates in a private blocklist, or the system administrator may dismiss, pause, or ignore the recommendations.

In examples, security services provider 210 may occasionally or on demand measure success rate that an inclusion of BLE candidates brings to private blocklist(s) of organizations from global blocklists and/or stratified blocklists. In examples, success rating unit 264 may be configured to determine success ratings for BLE candidates. In examples, success rating unit 264 may determine and provide an indication of how many messages are blocked by each BLE candidate that is included in a private blocklist over time. If success rating unit 264 determines that a particular BLE candidate is blocking a large number of messages across many organizations, success rating unit 264 may indicate that the BLE candidate may be blocking messages that are not actually threats (e.g., the BLE candidate is creating “false positives”). Similarly, if success rating unit 264 determines that a particular BLE candidate is not blocking many messages in private blocklist(s), success rating unit 264 may indicate that the BLE candidate may not be effective. In examples, false positive prevention unit 266 may be configured to identify BLE candidates that are creating false positives or BLE candidates that are not effective and may remove such BLE candidates from a global blocklist or a stratified blocklist and may recommend the removal of such BLE candidates from private blocklist(s) of organizations. In examples, false positive prevention unit 266 may be configured to determine if such BLE candidates have to be removed from the global blocklist and/or stratified blocklist(s) by comparing success rate of the BLE candidates in the global blocklist and/or stratified blocklist(s). In an example, if the number of messages blocked by the BLE candidate across a number of organizations over a period of time exceeds a threshold, false positive prevention unit 266 may remove the BLE candidate from a global blocklist and/or stratified blocklist(s) or may provide the BLE candidate to threat researcher 299 for review and/or may suspend the BLE candidate from a global blocklist and/or stratified blocklist(s) pending review by threat researcher 299. In examples, false positive prevention unit 266 may remove the BLE candidate from a stratified blocklist for a given industry if the number of messages blocked by the BLE candidate across a number of organizations in the particular industry, over a period of time exceeds a threshold. In examples, false positive prevention unit 266 may provide the BLE candidate to threat researcher 299 for manual review and/or may suspend the BLE candidate from the stratified blocklist for that industry pending review by threat researcher 299. In examples, security services provider 210 may indicate that one or more identified BLE candidates may need a review or may trigger a review of one or more identified BLE candidates within security services provider 210 itself. In examples, security services provider 210 may identify BLE candidates that are not blocking messages to a system administrator of an organization for review. In examples, security services provider 210 may recommend that one or more BLE candidates be removed from a private blocklist or one or more BLE candidates may be suspended for use in a private blocklist until reviewed by threat researcher 299 or the system administrator to determine whether the BLE candidate should be kept or permanently removed.

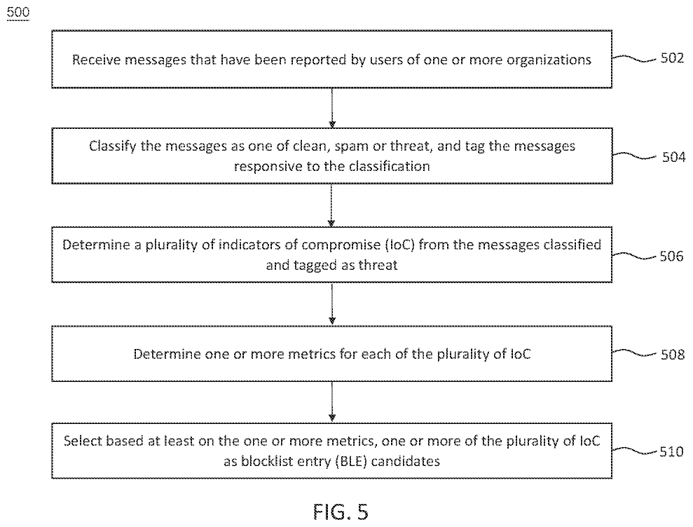

FIG. 5 depicts flowchart 500 for selecting one or more of a plurality of indicators of compromise (IoC) as blocklist entry (BLE) candidates, according to some embodiments.

In a brief overview of an implementation of flowchart 500, at step 502, messages that have been reported by users of one or more organizations may be received. At step 504, the messages may be classified as one of clean, spam or threat. At step 506, a plurality of IoC may be determined from the messages classified and tagged as threat. At step 508, one or more metrics may be determined for each of the plurality of IoC. At step 510, based at least on the one or more metrics, one or more of the plurality of IoC may be selected as BLE candidates.

Step 502 includes receiving messages that have been reported by users of one or more organizations. According to an implementation, message collection system 248 may receive the messages directly from email client plug-in 226-1 or indirectly from threat reporting system 206. In an implementation, message collection system 248 may process and prepare the reported messages for disposition. In examples, reported messages may include metadata or may not include metadata. In an implementation, metadata adder 250 may add metadata to the reported messages, for example, related to the organization, the user(s) and/or timestamp (for example, to reported message). In some implementations, message collection system 248 may store the incoming reported messages and/or the reported messages with metadata added by metadata adder 250 in message collection storage 252.

Step 504 includes classifying the messages as one of clean, spam or threat. According to an implementation, message classifier 254 may process the messages to classify the messages as one of clean, spam, or threat. In examples, message classifier 254 may use analysis tools 255 to classify the messages as one of clean, spam, or threat. In some implementations, message classifier 254 may tag the messages responsive to the classification.

Step 506 includes determining a plurality of IoC from the messages classified and tagged as threat. According to an implementation, IoC decomposer 278 may be configured to determine the plurality of IoC from the messages classified and tagged as threat. In an implementation, time stamp processor 276 may be configured to remove from the messages classified as threat, messages with a timestamp of receipt in a reporting user's mailbox before a predetermined time period before the classification. According to some implementations, IoC decomposer 278 may be configured to decompose the messages classified as threat and not removed by time stamp processor 276 to determine the plurality of IoC.

Step 508 includes determining one or more metrics for each of the plurality of IoC. According to an implementation, BLE candidate selector 259 may be configured to use metric calculator 281 to determine the one or more metrics for each of the plurality of IoC. In an implementation, severity metric calculator 282 may be configured to determine one or more metrics comprising a severity metric representing an extent of harm to an organization a message having an IoC can cause. In some implementations, breadth metric calculator 284 may be configured to determine one or more metrics comprising a breadth metric comprising a proportion of a number of organizations in which an IoC is included in the plurality of IoC from classified messages for a time period. In some implementations, prevalence metric calculator 286 may be configured to determine one or more metrics comprising a prevalence metric comprising a count of a number of times an IoC is included in the plurality of IoC from classified messages for a time period.

Step 510 includes selecting based at least on the one or more metrics, one or more of the plurality of IoC as BLE candidates. According to an implementation, BLE candidate selector 259 may be configured to select the one or more of the plurality of IoC as BLE candidates.

According to some implementations, BLE curator unit 262 may be configured to provide the BLE candidates to a system administrator of an organization for including in a private blocklist. In an implementation, IoC filter 280 may be configured to exclude from the plurality of IoC any IoC on a BLE exclusion list. According to some implementations, BLE candidate selector 259 may be configured to exclude as BLE candidates the plurality of IoC with the one or more metrics below a threshold value for the respective metric. In examples, the one or more metrics may include the prevalence metric or the breadth metric. According to an implementation, BLE candidate review unit 260 may be configured to determine, using an AI model, which of the BLE candidates are approved to be included in the private blocklist. In examples, the AI model may be trained on previous BLE candidates. In some implementations, BLE candidate review unit 260 may be the AI model.

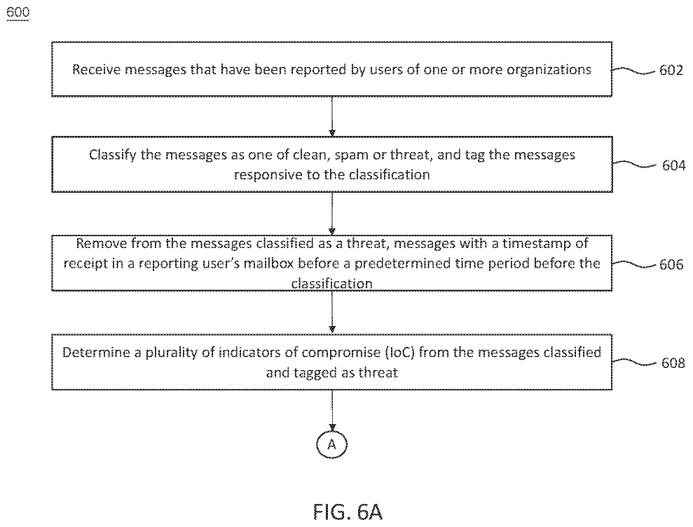

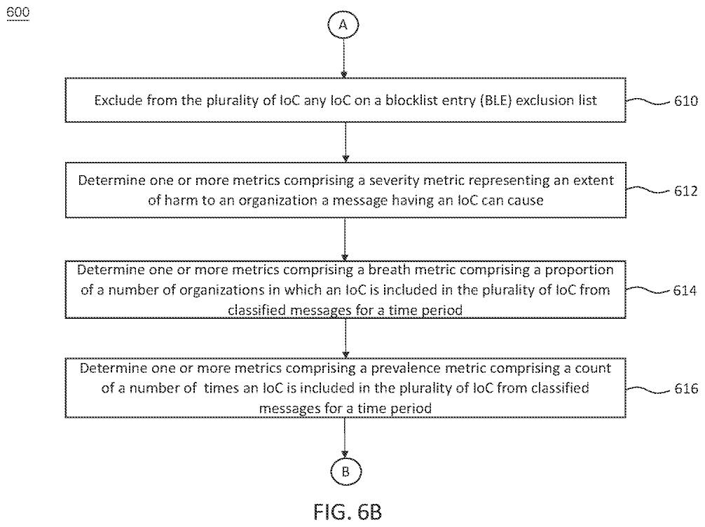

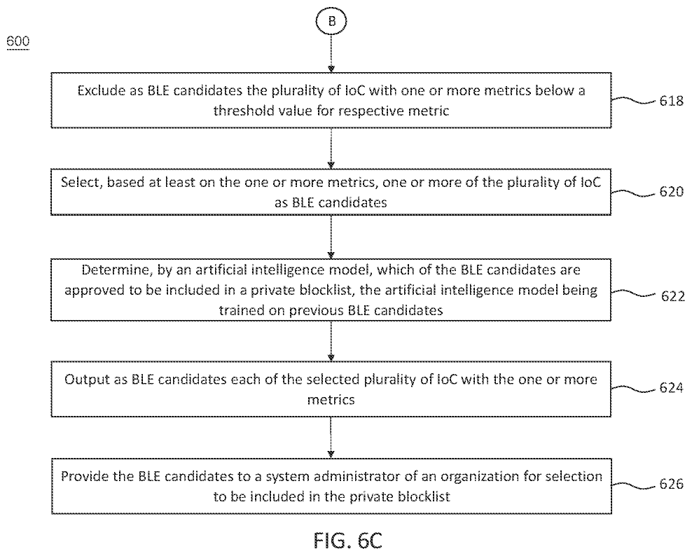

FIG. 6A, FIG. 6B, and FIG. 6C depict flowchart 600 for providing blocklist entry (BLE) candidates to a system administrator of an organization to be included in a private blocklist, according to some embodiments.

In a brief overview of an implementation of flowchart 600, at step 602, messages that have been reported by users of one or more organizations may be received. At step 604, the messages may be classified as one of clean, spam or threat. In examples, the messages may be tagged responsive to classification. At step 606, messages with a timestamp of receipt in a reporting user's mailbox before a predetermined time period before the classification may be removed from the messages classified as threat. At step 608, a plurality of IoC may be determined from the messages classified and tagged as threat. At step 610, any IoC on a BLE exclusion list may be excluded from the plurality of IoC. At step 612, one or more metrics comprising a severity metric representing an extent of harm to an organization a message having an IoC can cause may be determined. At step 614, one or more metrics comprising a breadth metric comprising a proportion of a number of organizations in which an IoC is included in the plurality of IoC from classified messages for a time period may be determined. At step 616, one or more metrics comprising a prevalence metric comprising a count of a number of times an IoC is included in the plurality of IoC from classified messages for a time period may be determined. At step 618, the plurality of IoC with one or more metrics below a threshold value for the respective metric may be excluded as BLE candidates. At step 620, one or more of the plurality of IoC as BLE candidates may be selected based at least on the one or more metrics. At step 622, it may be determined, by an artificial intelligence (AI) model, which of the BLE candidates are approved to be included in a private blocklist. In examples, the AI model may be trained on previous BLE candidates. At step 624, each of the selected plurality of IoC with the one or more metrics may be output as BLE candidates. At step 626, the BLE candidates may be provided to a system administrator of an organization for selection to be included in the private blocklist.

Step 602 includes receiving messages that have been reported by users of one or more organizations. According to an implementation, message collection system 248 may receive the messages directly from email client plug-in 226-1 or indirectly from threat reporting system 206. In an implementation, message collection system 248 may process and prepare the reported messages for disposition. In examples, messages may include metadata or may not include metadata. In an implementation, metadata adder 250 may add additional metadata to the reported messages, for example, related to the organization, the user(s) and/or timestamp (for example, to reported message. In some implementations, message collection system 248 may store the incoming reported messages and/or the reported messages with metadata added by metadata adder 25 in message collection storage 252.

Step 604 includes classifying the messages as one of clean, spam or threat, and tagging the messages responsive to the classification. According to an implementation, message classifier 254 may process the messages to classify the messages as one of clean, spam, or threat. In examples, message classifier 254 may use analysis tools 255 to classify the messages as one of clean, spam, or threat. In some implementations, message classifier 254 may tag the messages responsive to the classification.

Step 606 includes removing from the messages classified as threat, messages with a timestamp of receipt in a reporting user's mailbox before a predetermined time period before the classification. According to an implementation, time stamp processor 276 may be configured to remove from the messages classified as threat, messages with a timestamp of receipt in a reporting user's mailbox before a predetermined time period before the classification.

Step 608 includes determining a plurality of IoC from the messages classified and tagged as threat. According to an implementation, IoC decomposer 278 may be configured to determine the plurality of IoC from the messages classified and tagged as threat. According to some implementations, IoC decomposer 278 may be configured to decompose the messages classified as threat and not removed by time stamp processor 276 to determine the plurality of IoC.

Step 610 includes excluding from the plurality of IoC any IoC on a BLE exclusion list. According to an implementation, IoC filter 280 may be configured to exclude from the plurality of IoC any IoC on the BLE exclusion list.

Step 612 includes determining one or more metrics comprising a severity metric representing an extent of harm to an organization a message having an IoC can cause. According to an implementation, severity metric calculator 282 may be configured to determine one or more metrics comprising the severity metric representing the extent of harm to the organization the message having the IoC can cause.

Step 614 includes determining one or more metrics comprising a breadth metric comprising a proportion of a number of organizations in which an IoC is included in the plurality of IoC from classified messages for a time period. According to an implementation, breadth metric calculator 284 may be configured to determine the one or more metrics comprising the breadth metric comprising the proportion of the number of organizations in which the IoC is included in the plurality of IoC from classified messages for the time period.

Step 616 includes determining one or more metrics comprising a prevalence metric comprising a count of a number of times an IoC is included in the plurality of IoC from classified messages for a time period. According to an implementation, prevalence metric calculator 286 may be configured to determine the one or more metrics comprising a prevalence metric comprising a count of a number of times an IoC may be included in the plurality of IoC from classified messages for the time period.

Step 618 includes excluding as BLE candidates the plurality of IoC with one or more metrics below a threshold value for the respective metric.

According to an implementation, BLE candidate selector 259 may exclude as BLE candidates the plurality of IoC with one or more metrics below the threshold value for the respective metric. In examples, the one or more metrics includes the prevalence metric or the breadth metric.

Step 620 includes selecting, based at least on the one or more metrics, one or more of the plurality of IoC as BLE candidates. According to an implementation, BLE candidate selector 259 may select the one or more of the plurality of IoC as BLE candidates based at least on the one or more metrics.

Step 622 includes determining, by an AI model, which of the BLE candidates are approved to be included in a private blocklist. In examples, the AI model may be trained on previous BLE candidates. According to an implementation, BLE candidate review unit 260 may be the AI model that determines which of the BLE candidates are approved to be included in the private blocklist.

Step 624 includes outputting as BLE candidates, each of the selected plurality of IoC with the one or more metrics. According to an implementation, BLE curator unit 262 may be configured to output as BLE candidates, each of the selected plurality of IoC with the one or more metrics.

Step 626 includes providing the BLE candidates to a system administrator of an organization for selection to be included in the private blocklist. According to an implementation, BLE curator unit 262 may be configured to provide the BLE candidates to the system administrator of the organization for selection to be included in the private blocklist. In some implementations, BLE curator unit 262 may provide an interface (for example, user interface 275 or administrator interface 279) through which the system administrator can select the BLE candidates to be included in the private blocklist.

The systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMS, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed:

1. A method comprising:
receiving, by one or more servers, messages that have been reported by users of one or more organizations, the one or more servers storing the messages into a message collection system;
classifying, by the one or more servers, the messages as one of clean, spam or threat, the one or more servers tagging the messages responsive to the classification;
determining, by the one or more servers, a plurality of indicators of compromise from the messages classified and tagged as threat;
determining, by the one or more servers, one or more metrics for each of the plurality of indicators of compromise;
selecting, by the one or more servers based at least on the one or more metrics, one or more of the plurality of indicators of compromise as blocklist entry (BLE) candidates.

2. The method of claim 1, further comprising providing, by the one or more servers, the BLE candidates to a system administrator of an organization for selection to be included in a private blocklist.

3. The method of claim 1, further comprising removing, by the one or more servers, from the messages classified as a threat, messages with a timestamp of receipt in a reporting user's mailbox before a predetermined time period before the classification.

4. The method of claim 1, further comprising excluding, by the one or more servers, from the plurality of indicators of compromise any indicators of compromise on a BLE exclusion list.

5. The method of claim 1, further comprising determining, by the one or more servers, one or more metrics comprising a severity metric representing an extent of harm to an organization a message having an indicator of compromise can cause.

6. The method of claim 1, further comprising determining, by the one or more servers, one or more metrics comprising a breadth metric comprising a proportion of a number of organizations in which an indicator of comprise is included in the plurality of indicators of compromise from classified messages for a time period.

7. The method of claim 1, further comprising determining, by the one or more servers, one or more metrics comprising a prevalence metric comprising a count of a number of times an indicator of comprise is included in the plurality of indicators of compromise from classified messages for a time period.

8. The method of claim 1, further comprising excluding, by the one or more servers, as BLE candidates the plurality of indicators of compromise with one or more metrics below a threshold value for the respective metric, wherein the one or more metrics comprises a prevalence metric or a breadth metric.

9. The method of claim 1, further comprising determining, by an artificial intelligence model of the one or more servers, which of the BLE candidates are approved to be included in the blocklist, the artificial intelligence model being trained on previous BLE candidates.

10. The method of claim 1, further comprising outputting, by the one or more servers, as BLE candidates each of the selected plurality of indicators of compromise with the one or more metrics.

11. A system comprising:
one or more servers configured to:
receive messages that have been reported by users of one or more organizations, the one or more servers storing the messages into a message collection system;
classify the messages as one of clean, spam or threat and tag the messages responsive to the classification;
determine a plurality of indicators of compromise from the messages classified and tagged as threat;
determine one or more metrics for each of the plurality of indicators of compromise;
select based at least on the one or more metrics, one or more of the plurality of indicators of compromise as blocklist entry (BLE) candidates.

12. The system of claim 11, wherein the one or more servers are further configured to provide the BLE candidates to a system administrator of an organization for selection to be included in a private blocklist.

13. The system of claim 11, wherein the one or more servers are further configured to remove from the messages classified as a threat, messages with a timestamp of receipt in a reporting user's mailbox before a predetermined time period before the classification.

14. The system of claim 11, wherein the one or more servers are further configured to exclude from the plurality of indicators of compromise any indicators of compromise on a BLE exclusion list.

15. The system of claim 11, wherein the one or more servers are further configured to determine one or more metrics comprising a severity metric representing an extent of harm to an organization a message having an indicator of compromise can cause.

16. The system of claim 11, wherein the one or more servers are further configured to determine one or more metrics comprising a breadth metric comprising a proportion of a number of organizations in which an indicator of compromise is included in the plurality of indicators of compromise from classified messages for a time period.

17. The system of claim 11, wherein the one or more servers are further configured to determine one or more metrics comprising a prevalence metric comprising a count of a number of times an indicator of comprise is included in the plurality of indicators of compromise from classified messages for a time period.

18. The system of claim 11, wherein the one or more servers are further configured to exclude as BLE candidates the plurality of indicators of compromise with one or more metrics below a threshold value for the respective metric, wherein the one or more metrics comprises a prevalence metric or a breadth metric.

19. The system of claim 11, wherein the one or more servers are further configured to determine via an artificial intelligence model, which of the BLE candidates are approved to be included in the blocklist, the artificial intelligence model being trained on previous BLE candidates.

20. The system of claim 11, wherein the one or more servers are further configured to output as BLE candidates each of the selected plurality of indicators of compromise with the one or more metrics.
